(19) United States
(12) Patent Application Publication
(10) Pub. No.: US 2015/0163649 A1
(43) Pub. Date: Jun. 11, 2015

(54) SMARTPHONE BASED TELEMATICS APPLICATIONS

(71) Applicant: Innova Electronics, Inc., Irvine, CA (US)

(72) Inventor: Ieon C. Chen, Laguna Hills, CA (US)

(73) Assignee: Innova Electronics, Inc., Irvine, CA (US)

(21) Appl. No.: 14/102,287

(22) Filed: Dec. 10, 2013

(51) Int. Cl. H04W 4/16; H04W 4/04; H04W 4/00

(52) U.S. Cl. CPC H04W 4/16; H04W 4/008; H04W 4/04

(57) ABSTRACT

A system for monitoring vehicle operation during a driving experience of a vehicle using a smartphone having a position module configured to generate driving data associated with the position of the smartphone. The system includes a database for storing driving data generated by the smartphone, and computer executable instructions downloadable onto the smartphone. The computer executable instructions configures the smartphone to identify a first triggering event and a subsequent second triggering event, wherein the first triggering event is associated with the start of the driving experience and the second triggering event is associated with the end of the driving experience. The computer executable instructions further configures the smartphone to store driving data generated between the first and second triggering events in the database. The identifying step and storing step proceeding independent of receiving information from a vehicle onboard computer.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Technical Field of the Invention

The present invention relates generally to systems and methods of vehicle monitoring and tracking, and more specifically to such systems and methods which employ the capabilities of a conventional smartphone to obtain information related to a driving experience of an associated vehicle without communicating with a vehicle's onboard computer.

2. Description of the Related Art

Existing vehicle monitoring systems exist for a variety of reasons, such as determining insurance rates, fleet management and parental supervision. Conventional vehicle monitoring systems typically include a data retrieval device which is plug connectable to the vehicle's onboard diagnostic port to retrieve performance data from the vehicle's onboard computer. When the device is plugged into the vehicle, the device can monitor when the vehicle is turned on or off, as well as vehicle speed, engine RPM, braking data, engine temperature, sensor data, as well as diagnostic trouble codes which may be triggered during the driving experience. Most tracking devices further include a GPS module which allows for real-time position-tracking of the vehicle. The data received from the vehicle as well as from the GPS module is typically stored on an onboard memory module.

The data stored on the memory module may be uploaded to a monitoring station for review. In some instances, the device includes a long-range communication circuit to allow the device to independently upload the information to the remotely located monitoring station. This class of device is typically used in commercial fleet management systems, wherein real-time information may have heightened importance. For instance, a fleet manager will usually monitor the current location of the fleet of vehicles to ensure that the drivers are keeping on schedule, and to provide the fleet manager with up-to-date information in the event immediate re-routing is needed.

Other devices do not include long-range communication ability and require that the data stored on the memory module is downloaded therefrom, typically by unplugging the device from the vehicle and connecting the device to a computer (e.g., a desktop or laptop computer) for downloading information from the device to the computer. This class of device is typically used by insurance industries or in parental supervision applications, wherein the reviewer of the information (i.e., the insurance company or the parent) is more concerned with the driving habits of the driver over the duration of the driving experience, rather than obtaining real-time information.

Although the currently existing vehicle monitoring and tracking systems are capable of retrieving the desired vehicle data and providing vehicle data for review, such systems tend to suffer from one or more deficiencies. One of the most common drawbacks associated with such systems relates to the cost of owning and operating such systems. In particular, there is typically an initiation acquisition cost when buying the data retrieval devices, and then regular subscription fees (either monthly or yearly) for using the data retrieval devices and related data reviewing applications. For instance, the cost may exceed several hundred dollars a year for a single monitoring and tracking system. The overall cost of operating conventional monitoring and tracking systems may be compounded in the case of fleet management, wherein several data retrieval devices and related subscriptions are required to cover the entire fleet.

In view of the foregoing, there is a need in the art for a more cost effective vehicle monitoring and tracking system. Various aspects of the present invention are directed toward fulfilling this need, as will be described in more detail below.

### BRIEF SUMMARY OF THE INVENTION

Various aspects of the present invention specifically address and alleviate the above-identified deficiencies in the art. More specifically, the present invention is directed toward providing a vehicle monitoring and tracking system which utilizes the capabilities of a conventional smartphone and does not require dedicated hardware for establishing a communication link with the vehicle's onboard computer. In other words, the systems and methods described herein do not retrieve performance data from the vehicle computer, and instead, use information obtained from the user's smartphone. The vehicle information obtained by the system may have a wide range of practical uses, such as information-as-a-service (i.e., for insurance companies), parking location assistance, tax preparation, and fleet management.

According to one embodiment, there is provided a system for monitoring vehicle operation during a driving experience of a vehicle, wherein the vehicle includes a local wireless communication network. The system utilizes a smartphone that is configured to generate driving data associated with the position of the smartphone when the smartphone is in the vehicle. The system includes a database for storing driving data generated by the smartphone and computer executable instructions downloadable onto the smartphone. The computer executable instructions configure the smartphone to associate the beginning of the driving experience with establishment of a communication link between the smartphone and the local wireless communication network, and to associate the end of the driving experience with termination of the communication link between the smartphone and the local wireless communication network. The computer executable instructions further configure the smartphone to store driving data generated by the smartphone during the driving experience in the database such that the stored driving data represents movement of the vehicle during the driving experience.

The local wireless communication network may be associated with a unique network identifier, and the computer executable instructions may further configure the smartphone to associate the beginning of the driving experience with the establishment of a communication link between the smartphone and the local wireless communication network associated with the unique network identifier.

The database may be located in a remote server. The computer executable instructions may configure the smartphone to communicate the stored driving data to the remote server.

The computer executable instructions may configure the smartphone to associate driving data with a prescribed identifier in response to input received by the user. The computer executable instructions may configure the smartphone to display a user solicitation signal when one of the beginning and end of the driving experience occurs in a location not associated with a prescribed identifier. The user solicitation signal may include a request to associate the driving data with one of a plurality of preprogrammed position labels. The system may further include a mileage reporting module in communication with the database and configured to calculate mileage based on stored driving data associated with prescribed identifiers qualifying with tax reporting rules.

The system may include a mileage reporting module in communication with the database and configured to calculate mileage based on stored driving data. The mileage reporting module may be configured to selectively include driving data used in generating the report based on prescribed parameters. The prescribed parameters may be associated with tax reporting rules.

The computer executable instructions may further configure the smartphone to compare the stored driving data with mileage reporting rules, and store the driving data in a reporting database when the stored driving data complies with the mileage reporting rules.

The computer executable instructions may further configure the smartphone to assign the driving data associated with the end of the driving experience as a parked position and emit a signal corresponding to the parked position in response to a request by the user. The signal emitted by the smartphone may include a map depicted on a display of the smartphone showing the location of the parked position. The map may additionally show the real-time location of the smartphone relative to the location of the parked position.

The associating and storing steps performed by the smartphone may proceed independent of receiving information from a vehicle onboard computer.

According to another embodiment, the computer executable instructions may configure the smartphone to identify a first triggering event and a subsequent second triggering event, wherein the first triggering event is associated with the start of the driving experience and the second triggering event is associated with the end of the driving experience. The computer executable instructions may further configure the smartphone to store driving data generated between the first and second triggering events in the database, wherein the identifying step and storing step proceed independent of receiving information from a vehicle onboard computer.

The computer executable instructions may further configure the smartphone to associate the first triggering event with the smartphone being located in a prescribed geographic region during a prescribed time period. The computer executable instructions may further configure the smartphone to associate the second triggering event with the smartphone being located in a prescribed geographic region during a prescribed time period.

The computer executable instructions may further configure the smartphone to associate the first triggering event with movement of the smartphone above a prescribed speed threshold. The computer executable instructions may further configure the smartphone to associate the second triggering event with movement of the smartphone below a prescribed threshold for a prescribed period of time.

The computer executable instructions may further configure the smartphone to associate the first and second triggering events with respective first and second user inputs received by the smartphone from the user.

According to yet another embodiment of the present invention, there is provided a method of monitoring vehicle operation during a driving experience of a vehicle using a smartphone having a position module configured to generate driving data associated with the position of the smartphone. The method includes the steps of: identifying a first triggering event associated with the start of the driving experience based on information at the smartphone; identifying a subsequent second triggering event associated with the end of the driving experience based on information at the smartphone; and storing driving data generated between the first and second triggering events in a database; the identifying steps proceeding independent of receiving information from a vehicle onboard computer.

The present invention is best understood by reference to the following detailed description when read in conjunction with the accompanying drawings.

### BRIEF DESCRIPTION OF THE DRAWINGS

These as well as other features of the present invention will become more apparent upon reference to the drawings wherein:

FIG. 1 is a schematic view of a vehicle monitoring system constructed in accordance with an embodiment of the present invention;

FIG. 2 is a schematic view of a geographical area associated with an embodiment of the vehicle monitoring system;

FIG. 3 is a schematic view of a smartphone configured for use in locating the location of a parked vehicle;

FIG. 4 is a map showing positional information associated with a vehicle; and

FIG. 5 is a map showing positional information associated with first and second vehicles.

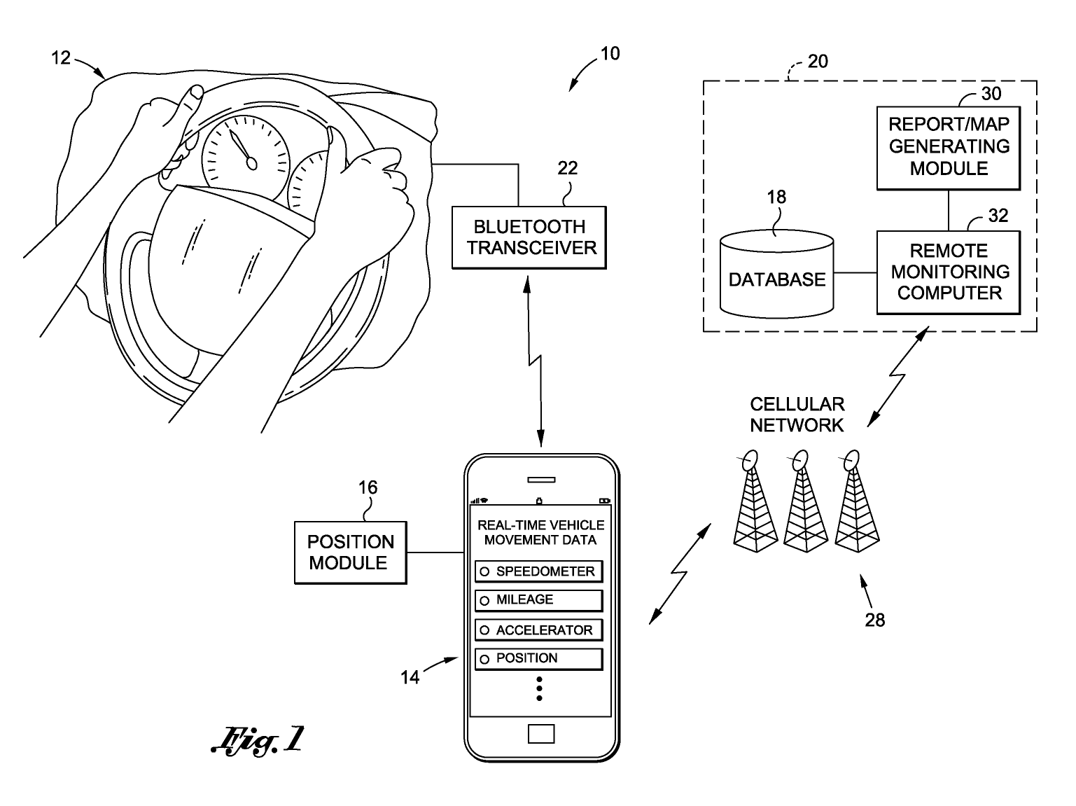

Common reference numerals are used throughout the drawings and detailed description to indicate like elements.

### DETAILED DESCRIPTION OF THE INVENTION

Referring now to the drawings, wherein the showings are for purposes of illustrating a preferred embodiment of the present invention only, and are not for purposes of limiting the same, there is depicted a system 10 configured to track the movement of a vehicle 12 using driving data generated by a smartphone 14 located within and associated with the vehicle 12. The smartphone 14 includes a position module 16, e.g., a GPS module, which continuously generates driving data associated with the global position of the smartphone 14 as the vehicle 12 moves due to the smartphone 14 being located within the vehicle 12. The driving data may also be associated with time data (which may be generated by a clock on the smartphone 14) to calculate operational data of the vehicle 12, such as speed and acceleration/deceleration.

In this regard, the smartphone 14 may obtain position and operational data of the vehicle 12 without requiring information from an onboard vehicle computer, which is typically required in conventional vehicle tracking systems. Therefore, various aspects of the present invention provide a simple and more economical vehicle monitoring alternative to many conventional vehicle monitoring systems.

The information collected by the smartphone 14 may be useful in wide-ranging applications. For instance, a user's mileage information (i.e., average daily distance traveled) and typical driving location may be particularly useful to an insurance company for setting insurance rates. To that end, various aspects of the present invention may be directed toward collecting driving data for a plurality of users and providing Information-as-a-Service (IAAS). It is also contemplated that the driving data collected by the system 10 may be useful for IRS Reporting or other mileage reporting applications. Furthermore, the driving data may also be utilized in a car-locating application, which may be helpful for locating one's car in a large parking lot.

As used herein, the term “smartphone” is understood to include a mobile phone built on a mobile operating system, and preferably includes advanced computing capability which allows the mobile phone to communicate both voice and data over a wireless communication network. Exemplary smartphones include the Apple iPhone™ or the Samsung Galaxy Note™ although other smartphones currently existing or later developed may also be used in connection with various aspects of the present invention. It is also understood that the term “smartphone” may be broad enough to encompass other handheld communication devices, such as tablet computers (e.g., an iPad™), PDAs, or other handheld/portable communication devices developed in the art.

The system 10 preferably includes a smartphone application (i.e., a smartphone “app.”) including software comprising computer executable instructions which are downloadable onto the smartphone 14 for configuring the smartphone 14 to store driving data associated with movement of the vehicle 12. The driving data is stored on a database 18 and may be displayed on a remote computing device 20, such as a desktop computer, laptop computer, tablet computer, smartphone or other computing device. The driving data displayed on the remote computing device 20 may include the real time position of the vehicle 12 associated with the smartphone 14, the recent/current speed or acceleration of the vehicle 12 or the position history of the vehicle 12.

### Information-as-a-Service

According to one embodiment, the smartphone application configures the smartphone 14 to conduct monitoring/tracking operations when the smartphone 14 is paired with a vehicle's onboard local wireless communication network 22. Those skilled in the art will recognize that several models of modern vehicles 12 include a built-in, local wireless communication network 22 on the vehicle 12 for enabling the vehicle 12 to wirelessly communicate with one or more peripheral devices, such as a smartphone 14. For instance, newer vehicles 12 include a local wireless communication network 22 configured to transmit and receive signals in a Bluetooth™ protocol for pairing a smartphone 14 with one or more of the vehicle's systems, such as the vehicle's audio system for playback of music stored/streamed through the smartphone 14 or for placing/receiving phone calls using onboard microphone(s) and speakers. Thus, when the smartphone 14 becomes paired/connected with the local wireless communication network 22, the smartphone 14 recognizes that event as a first triggering event to initiate monitoring/tracking operations. Subsequently, when the communications link between the smartphone 14 and local wireless communication network 22 is terminated, the smartphone 14 recognizes that event as a second triggering event, which terminates the monitoring/tracking operations.

Although it is recognized that many modern vehicles include built-in local wireless communication networks 22, it is also contemplated that the local wireless communication network 22 may a third party, aftermarket device which is not built-in the vehicle. It is contemplated that the scope of the present invention includes such aftermarket wireless communication networks, as well as the built-in wireless communication networks.

According to various aspects of the present invention, it is contemplated that the pairing of the smartphone 14 with the local wireless communication network 22 is simply used to denote that the smartphone 14 is located in the vehicle 12 and to initiate the monitoring/tracking functionality on the smartphone 14. In other words, according to one embodiment, the smartphone 14 does not use data received from the local wireless communication network 22 as driving data used in monitoring/tracking the vehicle during a driving experience. Thus, the essence of the invention allows for monitoring/tracking without requiring dedicated hardware specifically designed to communicate directly with the vehicle's onboard computer.

The local wireless communication network 22 is associated with a unique network identifier which may include a unique electronic address number or other electronic identifier. The smartphone application is operative to configure the smartphone 14 to associate the first triggering event with the establishment of a wireless communication link between the smartphone 14 and the local wireless communication network 22 associated with a prescribed unique network identifier. In other words, the smartphone application may configure the smartphone 14 to associate the first triggering event with pairing of the smartphone 14 with the local wireless communication network 22 associated with the unique network identifier assigned by a user.

The advantage of associating the first triggering event with the pairing the smartphone and local wireless communication network 22 is that smartphone 14 may automatically recognize the first triggering event without any input into the smartphone 14 by the user. Furthermore, the smartphone 14 will preferably only associate the first triggering event with the particular vehicle 12 assigned to the user. Thus, if the user brings the smartphone 14 into another vehicle which has a local wireless communication network 22 assigned with a different network identifier, the smartphone 14 typically is not programed to pair with the local wireless communication network, and consequently, the first triggering event is not correlated to such action. Therefore, if a husband and wife each have separated smartphone(s) 14 and separate vehicle(s) 12, when the wife is a passenger in the husband's vehicle 12 driven by the husband, the first triggering event will only occur on the husband's smartphone 14, and not the wife's smartphone 14, since only the husband's smartphone 14 is programed to recognize the unique identifier associated with the local wireless communication network 22 associated with the husband's vehicle 12. Likewise, if the husband is a passenger in the wife's vehicle 12, only the wife's smartphone 14 will be recognize the first triggering event, since only the wife's smartphone 14 is programmed to recognize the unique identifier associated with the local wireless communication network 22 on the wife's vehicle 12.

When the first triggering event has occurred, the smartphone application configures the smartphone 14 to monitor and track movement of the smartphone 14, which in turn allows for monitoring and tracking of movement of the vehicle 12. For instance, the smartphone 14 may include a GPS module 16 which allows for tracking of position information associated with the smartphone 14 and the vehicle 12. The position information may also allow for calculation of velocity and acceleration information. Alternatively, the smartphone 14 may include an accelerometer which can independently track acceleration/deceleration as well as velocity information of the smartphone 14.

As noted above, the particular driving characteristics associated with the driving data collected by the system 10 may have particular benefit for insurance companies for setting insurance rates. For instance, if the collected driving data shows that the driver regularly drives long distances, through dangerous areas, in an aggressive manner, the insurance company may set a high insurance rate. Conversely, if the driving data shows that the driver regularly drives shorter distances, through relatively safe areas, in a conservative manner, the insurance company may set a low insurance rate.

The driving data may also allow the smartphone 14 to keep track of the mileage traveled by the vehicle 12, which may be helpful for the owner of the vehicle 12 for scheduling oil changes, brake replacements, and other routine maintenance procedures for the vehicle 12. In this regard, the smartphone application may configure the smartphone 14 to generate and send a maintenance signal to a repair garage to automatically schedule the needed maintenance once a prescribed mileage threshold is achieved.

The information which is gathered in during the monitoring/tracking operation may be stored on a database 18. The database 18 may be local on the smartphone 14 or alternatively remote from the smartphone 14. A local database on the smartphone 14 may be used for buffering the data before the data is ultimately communicated to a remote database. Once the information has been communicated from the smartphone 14, the information in the local database may be deleted to create storage space for new data.

The remote database 18 may be accessed by monitoring personnel, which may include a parent of a teenage driver, fleet management, an insurance company or other third parties. The information on the remote database 18 may be also accessed by the driver of the vehicle 12 after the driving experience has concluded.

The smartphone application may configure the smartphone 14 to generate the driving data continuously, or at regular intervals, until termination of the wireless communication link between the smartphone 14 and local wireless communication network 22. Such termination of the wireless communication link may occur when the vehicle 12 is turned off, when a door is open, or when the user carries the smartphone 14 out of the wireless range of the local wireless communication network 22. According to various implementations, the local wireless communication network 22 may define a wireless range of ten (10) feet, while in another embodiment the wireless range may only be only five (5) feet, although the distance associated with the wireless range may be greater than ten (10) fee or less than five (5) feet without departing from the spirit and scope of the present invention. When the wireless communication link is terminated, the smartphone 14 stops the monitoring and tracking operation and resets the smartphone 14 to detect a subsequent first triggering event.

Although the above described embodiment correlates the first and second triggering events with pairing of the smartphone 14 with the local wireless communication network 22 of the vehicle 12, it is understood that many vehicles 12 operate today without an onboard local wireless communication network 22. Therefore, other implementations of the present invention are directed toward correlating the first and second triggering events with other operational conditions associated with the beginning of a driving experience as well as the ending of a driving experience.

For instance, one embodiment associates the first triggering event with movement of the smartphone 14 above a prescribed speed threshold, while the second triggering event may be associated with movement of the cellphone 14 below a prescribed threshold. In this regard, the first triggering event may occur when the smartphone 14 is moved above 10 miles per hour (mph), while the second triggering event may be triggered when the smartphone 14 stops moving (recognizing that in most cases, the smartphone 14 will come to a complete stop, or a substantially complete stop, before movement of the smartphone 14 attributable to the user walking, rather than driving).

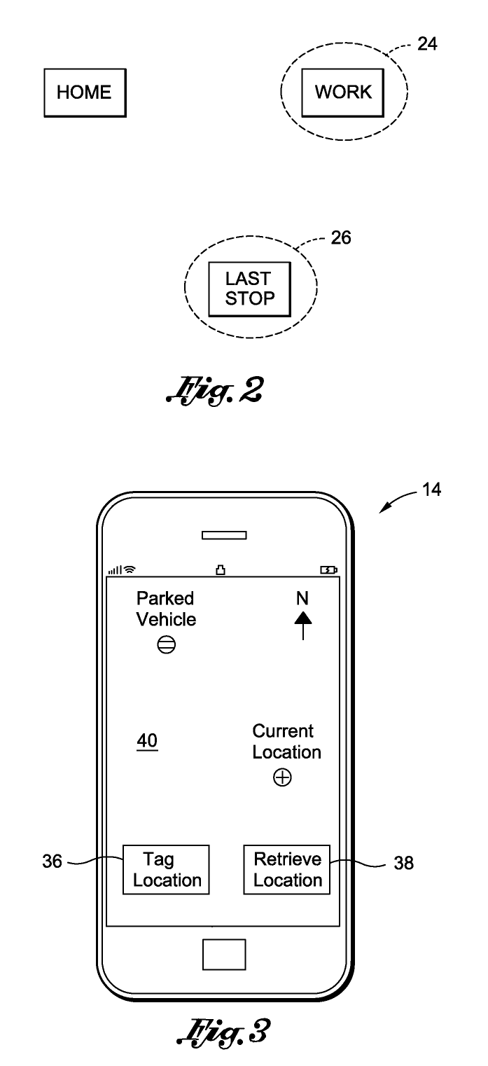

According to another embodiment, the first and/or second triggering events may be associated with the smartphone 14 being located in a certain geographic region, within a prescribed time range. This particular implementation may have particular advantages when monitoring and tracking a company vehicle stored on a company storage lot. In this regard, and referring now to FIG. 2, the company may be interested in monitoring and tracking the employee's driving of the company vehicle which is picked up at the company lot at the beginning of a shift and returned to the company lot at the end of a shift. Alternatively, the end of the shift may occur when the employee makes the last stop on his route, or visits the final customer for the day. Along these lines, the monitoring and tracking application may be triggered when the employee arrives with a smartphone 14 within a defined first triggering region associated with the storage lot at the beginning of his scheduled work shift. Thus, in order for the first triggering event to arise, two conditions must occur: the first condition being that the smartphone 14 is within the defined first triggering region 24 within a first time interval and that the smartphone 14 exceeds preset thresholds such as moving a prescribed speed and moving in a defined direction. Likewise the second triggering event may require two conditions: the first being that smartphone 14 is located within a defined second triggering region 26 (which may be the same or different from the first triggering region) and the speed of the smartphone 14 is zero, or substantially zero.

In other embodiments, the first and second triggering events may be manually entered by the user. Along these lines, smartphone application may configure the smartphone 14 to assign a first button to the first triggering event and a second button to the second triggering event to allow the user to enter the first and second triggering events by actuating the first and second buttons respectively. Thus, when the user actuates the first button, the smartphone 14 may begin tracking the movement of the smartphone 14 until the user actuates the second button, which signifies the end of the driving experience.

As noted above, the information obtained by the smartphone 14 relating to the driving experience is uploaded to the database 18. According to one embodiment, the information is communicated using the smartphone's long-range communication capability to upload the information to the remote database 18 via a cellular communications network 28. It is also contemplated that the information may be transferred from the smartphone 14 to a local computer (e.g., desktop, laptop, or tablet) for communication to the database 18. The database 18 may be located in the local computer or the database 18 may be located remotely, and the local computer may be used for communicating the information to remote database 18, such as uploading the information to the database 18 via a website (which may be a subscription-based web site).

### Parking Finder

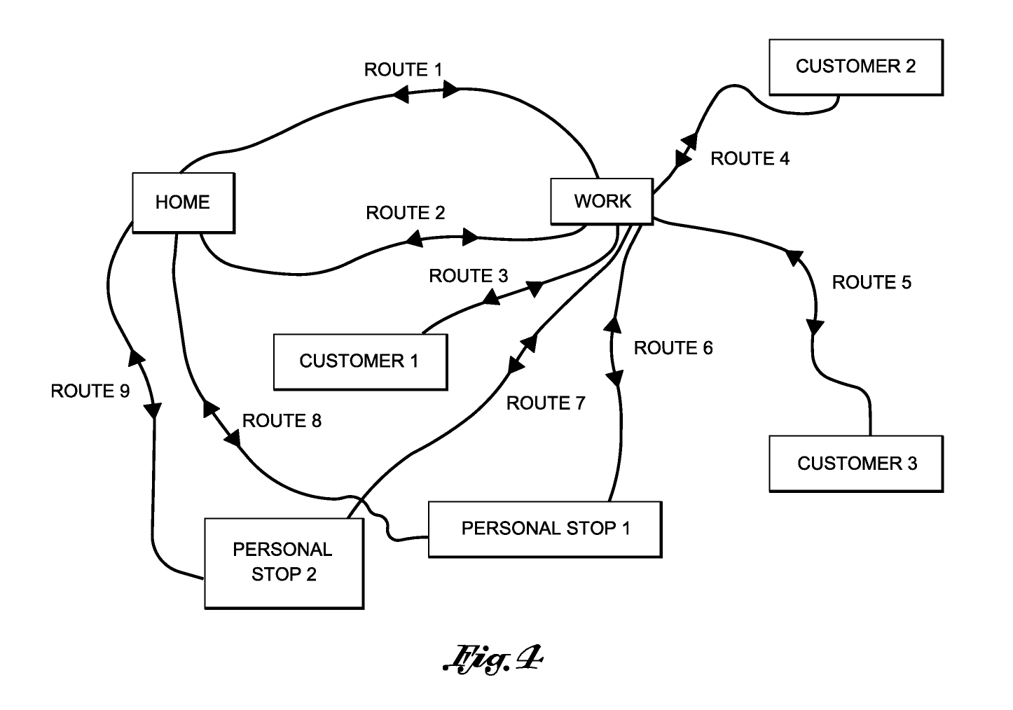

The system's ability to autonomously collect driving data may also be useful in marking the location of the vehicle 12 when the vehicle 12 is parked. In this regard, the system 10 may automatically store the driving data associated with the conclusion of the driving experience. The conclusion of the driving experience may be associated with the termination of the wireless communication link between the smartphone 14 and the local wireless communication network 22, which may occur when the user turns off the vehicle, opens a door or removes the vehicle from the wireless range. The conclusion of the driving experience may also be associated with the second triggering event, as described in more detail above. In other embodiments, the computer executable instructions may configure the smartphone 14 to display a button 36 which causes the smartphone 14 to tag the location of the parked vehicle 12 in response to the user actuating the button 36, as shown in FIG. 3.

The user may selectively retrieve the marked position of the vehicle 12 when the user wants to return to the parked vehicle 12. Therefore, when the user parks his vehicle 12 in a crowded parking lot, such as at a mall, sporting event, or the like, the parking finder functionality will allow the user to easily identify the location of the vehicle 12. The user may retrieve the parked location by actuating a button 38 on the smartphone 14, which causes the smartphone 14 to retrieve the parked location and display the parked location on a map 40 on the smartphone 14. The map 40 may depict the location of the parked vehicle, as well as the real-time location of the smartphone 14, which is carried by the user. The button(s) 36, 38 may be virtual buttons on a touchscreen, or physical buttons formed on the smartphone 14. The parked location may also be retrieved and displayed in response to a verbal command.

### Mileage Reporting

As noted above, one feature of the system 10 is the ability to track mileage during a driving experience, as well as the location of start and end of the driving experience. These capabilities may be particularly suited for tracking and reporting mileage for tax purposes or other mileage reimbursement purposes, such as reimbursement through the user's employer.

In the past, mileage information for reimbursement or tax reports was typically tracked via hand-written notes, which was very cumbersome and time consuming. Furthermore, conventional hand-written tracking methods were prone to abuse and mistake, as there was not an easy way to confirm and verify the authenticity and accuracy of such information.

In order to address the deficiencies associated with the conventional mileage tracking methods, various aspects and implementations of the present invention are directed toward a system which more easily tracks mileage for purposes of submitting a reimbursement report or tax report in accordance with mileage reporting rules or tax reporting rules. In particular, such systems may be configured to automatically sort mileage that qualifies as being tax-deductible or reimbursable from mileage that is not tax-deductible or reimbursable. For instance, according to certain tax codes, the mileage traveled between an individual's home and office typically does not qualify as mileage which may be deducted for tax purposes. On the other hand, mileage between the individual's home and a client's office, or between the individual's office and a client's office may be deduced for reported for tax deducting purposes. Other deductible mileage may include mileage related to moving, charitable functions, job search, and educational purposes. For additional information regarding federal tax rules and guidelines related to deducting expenses related to the operation of a vehicle, please see www.irs.gov, as well as Section 274(d) of the IRS code and Section 1.274-5 of the Income Tax Regulations. It is understood that employers may also provide mileage reimbursement for certain trips, which may or may not be consistent with the tax codes.

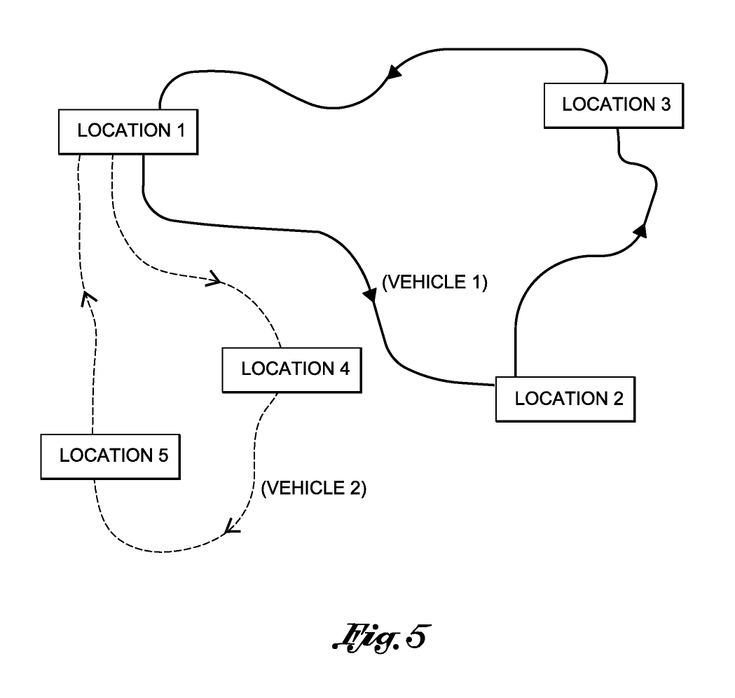

According to one embodiment, the system 10 may be configured by a user to allow the user to selectively tag “locations” or destinations that the user regularly visits, such as the user's home, office/work, various customers, restaurants, fitness center, etc. Furthermore, the system 10 additionally allows the user to categorize the preset destinations as being “qualifying” destinations or “non-qualifying” destinations for purposes of tax reporting or reimbursement. As shown in FIG. 4, the “qualifying locations” may include WORK, CUSTOMER 1, CUSTOMER 2, and CUSTOMER 3, while the “non-qualifying locations” include PERSONAL STOP 1, and PERSONAL STOP 2. Therefore, when the user travels between two “qualifying” destinations, the system 10 will automatically categorize the mileage between those destinations as being tax-deductible or reimbursable mileage. Conversely, if the user travels between two non-qualifying destinations or between one qualifying destination and one non-qualifying destination, the system 10 may automatically categorize the mileage between those destinations as being non-deductible or non-reimbursable mileage. The system 10 may additionally include an override capability to allow a user to disregard the aforementioned default settings. For instance, the mileage between the user's office and a restaurant the user frequents personally may have a default categorization as being non-deductible. However, if the user drives from the office to the restaurant to meet with a client, the user may override the default setting on a one-time basis, which causes the system 10 to categorize the mileage for that particular trip as being deductible mileage. Of course, the override functionality may also allow the user to change the default from deductible to non-deductible as well.

The tagging of locations may be done during the initial setup of the system 10. For instance, the setup may ask the user to enter the address of various locations the user frequently visits, such as the user's home(s), office(s), fitness center(s), restaurant(s), mall(s), client(s), church(es), etc. The initial setup may be conducted directly on the smartphone or via a website associated with the smartphone application.

In addition to the tagging done during the initial setup, the system 10 may also allow tagging as the system is used. In particular, when the user drives to an untagged location, the system 10 may allow the user to tag the location. The system 10 may be configured to automatically solicit the tagging from the user when the beginning or end of the driving experience occurs in an untagged location. For instance, when the start or end of the driving experience (or several minutes after the driving experience, so as not to interfere with the user's driving) occurs at a location that has not been previously tagged, the smartphone 14 may be configured to generate an alert to inquire into whether the user desires to tag that location. The alert may include an audible signal, as well as a display on the smartphone 14, such as, “Do you want to tag this location?” If the user does want to tag the location, the system 10 may allow the user to name that location. If the user does not want to tag the location, the user may be given the option of continuing the tracking functionality with the location being referred to generically, i.e., LOCATION 1. Alternatively, if the user does not want to tag the location, the user may be given the option to turn the mileage tracking functionality off. The system 10 may also be configured to allow the user to initiate the tagging without solicitation from the smartphone 14.

Therefore, when the user completes a trip between two locations for the first time, the smartphone may generate an alert to inquire into whether the user wants to categorize or label that trip. Once the locations have been tagged and the trip is categorized, the system 10 may automatically track and categorize the trip without any input by the user. For instance, if the user has tagged his OFFICE and CLIENT, and categorized a trip therebetween as a WORK trip, then the system 10 will default to tracking every trip between the OFFICE and CLIENT. If for any reason the user does not want the mileage tracked, the user may enter a signal (i.e., actuate an override button), which overrides the default setting.

In addition to tagging locations, the system 10 may further be configured to categorize trips between certain destinations based on categories assigned by the user. For instance, the user may assign trips between the office and various clients as a “WORK” category. The user may further assign trips between the home and various entertainment destinations, i.e., theater, as an “ENTERTAINMENT” category, while trips between the home and a relative's house may be categorized as ‘PERSONAL.” In this regard, the names of the locations and categories may be defined by the user, although the system 10 may include pre-defined category titles/headings which may be used by the user.

The mileage tracking system mitigates the burden of tracking one's mileage by hand, and allows the user's smartphone to automatically track the mileage information when the user completes a trip. The mileage information stored by the system may be printed in a report which may provide documentation or information needed to corroborate the corresponding reimbursements or deductions. Furthermore, the smartphone application may additionally allow the mileage information to be imported into a tax reporting form, or the like.

### Fleet Management

The monitoring/tracking capabilities of the system 10 may also find useful application as a fleet management system. Referring now specifically to FIG. 5, there is shown an exemplary map of how various implementations of the above-described system may be useful in fleet management applications as a means for simultaneously monitoring a plurality of vehicles. The map shows the position history of two different vehicles monitored by a remote fleet manager. LOCATION 1 may be representative of the company's home office or headquarters, as both vehicles (i.e., VEHICLE 1 and VEHICLE 2) begin their respective journeys at LOCATION 1. After leaving LOCATION 1, VEHICLE 1 continues to LOCATIONS 2 and 3, while VEHICLE 2 continues to LOCATIONS 4 and 5. The map depicted in FIG. 3, which shows the position information pertaining to VEHICLES 1 and 2, may be generated by a report/map generating module 30 in operative association with the database 18 to retrieve the driving experience data therefrom and displayed on a monitoring computer 32. Each vehicle may be associated with a different illustration pattern (i.e., solid line, dotted line, different color, etc.).

According to one embodiment, one or more LOCATIONS visited by the VEHICLES may be tagged or assigned as a reference location, such that the smartphone 14 automatically reports back to the remote monitoring station (e.g., the database 18) when the VEHICLE arrives at the location. In this regard, the fleet manager/parent may automatically receive updates as the VEHICLE arrives at prescribed destinations. The precision location of such “destinations of interest” may be selectively tagged by the fleet manager/parent.

In addition to the foregoing, it is also contemplated that various implementations of the systems and methods described herein may be useful for tracking personal vehicle performance information, which may satisfy personal curiosity, or may be useful for economic purposes. Referring now to FIG. 4, there is depicted a position history map of a single vehicle over a period of time. The information shown in FIG. 4 may also have associated travel times between the various locations. As such, the information may be useful to determine the most efficient route between two points. For instance, ROUTE 1 and ROUTE 2 indicate two different routes between the user's HOME and WORK. The user may determine that one of the two routes is quicker, and therefore, a more desirable route to travel on a regular basis.

### Other Applications

Although the foregoing describes the use of one's smartphone for purposes of storing data associated with the movement of a vehicle, it is also contemplated that various aspects of the present invention may apply to data storage during the use of other electronic devices. Along these lines, it is contemplated that other embodiments of the invention may utilize pairing of the smartphone with a wireless communication network as a triggering mechanism for activating sensors on the smartphone and/or storing data generated by the smartphone. The wireless communication network may be any wireless communication network. For instance, the wireless communication network may be part of a home-based device, such as a senior citizen health monitor. The health monitor may emit a wireless signal that is recognized by the smartphone, and used by the smartphone to initiate data collection and storage. Such data may include the position of the individual, the local temperature, as well as information generated by the health monitor, such as the individual's vital information (i.e., heart rate, body temperature, blood pressure, etc.).

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A system for monitoring vehicle operation during a driving experience of a vehicle having a local wireless communication network using a smartphone configured to generate driving data associated with the position of the smartphone when the smartphone is in the vehicle, the system comprising:
a database for storing driving data generated by the smartphone; and
computer executable instructions downloadable onto the smartphone for configuring the smartphone to:
associate the beginning of the driving experience with establishment of a communication link between the smartphone and the local wireless communication network;
associate the end of the driving experience with termination of the communication link between the smartphone and the local wireless communication network; and
store driving data generated by the smartphone during the driving experience in the database such that the stored driving data represents movement of the vehicle during the driving experience.

2. The system recited in claim 1, wherein the local wireless communication network is associated with a unique network identifier, the computer executable instructions further configuring the smartphone to associate the beginning of the driving experience with the establishment of a communication link between the smartphone and the local wireless communication network associated with the unique network identifier.

3. The system recited in claim 1, wherein the database is located in a remote server, the computer executable instructions further configuring the smartphone to communicate the stored driving data to the remote server.

4. The system recited in claim 1, wherein the computer executable instructions configure the smartphone to associate driving data with a prescribed identifier in response to input received by the user.

5. The system recited in claim 4, wherein the computer executable instructions configure the smartphone to display a user solicitation signal when one of the beginning and end of the driving experience occurs in a location not associated with a prescribed identifier.

6. The system recited in claim 5, wherein the user solicitation signal includes a request to associate the driving data with one of a plurality of preprogrammed position labels.

7. The system recited in claim 4, further comprising a mileage reporting module in communication with the database and configured to calculate mileage based on stored driving data associated with prescribed identifiers qualifying with tax reporting rules.

8. The system recited in claim 1, further comprising a mileage reporting module in communication with the database and configured to calculate mileage based on stored driving data.

9. The system recited in claim 8, wherein the mileage reporting module is configured to selectively include driving data used in generating the report based on prescribed parameters.

10. The system recited in claim 7, wherein the prescribed parameters are associated with tax reporting rules.

11. The system recited in claim 1, wherein computer executable instructions further configure the smartphone to compare the stored driving data with mileage reporting rules, and store the driving data in a reporting database when the stored driving data complies with the mileage reporting rules.

12. The system recited in claim 1, wherein the computer executable instructions further configure the smartphone to assign the driving data associated with the end of the driving experience as a parked position and emit a signal corresponding to the parked position in response to a request by the user.

13. The system recited in claim 12, wherein the signal emitted by the smartphone is a map depicted on a display of the smartphone showing the location of the parked position.

14. The system recited in claim 13, wherein the map additionally shows the real-time location of the smartphone relative to the location of the parked position.

15. The system recited in claim 1, wherein the associating and storing steps proceed independent of receiving information from a vehicle onboard computer.

16. A system for monitoring vehicle operation during a driving experience of a vehicle using a smartphone configured to generate driving data associated with the position of the smartphone when the smartphone is in the vehicle, the system comprising:
a database for storing driving data generated by the smartphone;
computer executable instructions downloadable onto the smartphone for configuring the smartphone to:
identify a first triggering event and a subsequent second triggering event, the first triggering event being associated with the start of the driving experience and the second triggering event being associated with the end of the driving experience; and
storing driving data generated between the first and second triggering events in the database;
the identifying step and storing step proceeding independent of receiving information from a vehicle onboard computer.

17. The system recited in claim 16, wherein the computer executable instructions further configures the smartphone to associate the first triggering event with the smartphone being located in a prescribed geographic region during a prescribed time period.

18. The system recited in claim 17, wherein the computer executable instructions further configures the smartphone to associate the second triggering event with the smartphone being located in a prescribed geographic region during a prescribed time period.

19. The system recited in claim 16, wherein the computer executable instructions further configures the smartphone to associate the first triggering event with movement of the smartphone above a prescribed speed threshold.

20. The system recited in claim 16, wherein the computer executable instructions further configures the smartphone to associate the second triggering event with movement of the smartphone below a prescribed threshold for a prescribed period of time.

21. The system recited in claim 16, wherein the computer executable instructions further configures the smartphone to associate the first and second triggering events with respective first and second user inputs received by the smartphone from the user.

22. A method of monitoring vehicle operation during a driving experience of a vehicle using a smartphone having a position module configured to generate driving data associated with the position of the smartphone, the method comprising the steps of:
identifying a first triggering event associated with the start of the driving experience based on information at the smartphone;
identifying a subsequent second triggering event associated with the end of the driving experience based on information at the smartphone; and
storing driving data generated between the first and second triggering events in a database;
the identifying steps proceeding independent of receiving information from a vehicle onboard computer.

23. A system for storing data generated by a smartphone when the smartphone is in communication with a local wireless communication network having a unique wireless ID, the system comprising:
computer executable instructions downloadable on the smartphone for configuring the smartphone to:
identify the unique wireless ID associated with a particular local wireless communication network;
record data generated by at least one of the smartphone and the local wireless communication network when communication is established between the smartphone and the local wireless communication network associated with the unique wireless ID; and
upload the recorded data to a remote location in accordance with upload instructions.

24. The system recited in claim 23, wherein the computer executable instructions include a smartphone application.

25. The system recited in claim 23, wherein the data generated by the smartphone is derived from a smartphone sensor selected from the group including: GPS sensor, accelerometer sensor, and timing sensor.

26. The system recited in claim 23, wherein the local wireless communication network includes a vehicle equipped with a wireless communication network.

27. The system recited in claim 26, wherein the local wireless communication network is built-in to the vehicle.

28. The system recited in claim 26, wherein the local wireless communication network is an aftermarket device.

29. The system recited in claim 23, wherein the local wireless communication network is located on an electrical appliance.

30. The system recited in claim 23, wherein the upload step is triggered by pre-programmed conditions.

31. The system recited in claim 23, wherein the upload step is triggered by programmable conditions.

32. The system recited in claim 23, wherein the computer executable instructions further configure the smartphone to:
receive data from the local wireless communication network; and
upload the data received from the local wireless communication network.
